(19) United States
(12) Patent Application Publication
(10) Pub. No.: US 2025/0289063 A1
(43) Pub. Date: Sep. 18, 2025

(54) CHUCK JAW, CHUCK INSERT AND CHUCK

(71) Applicant: Roehm GmbH, Sontheim/Brenz (DE)

(72) Inventors: Martin STANGL, Nersingen (DE); Christian NEUBAUER, Moenchsdeggingen (DE); Andreas DOLPP, Syrgenstein (DE); Jens GRAESSLE, Heidenheim (DE); Martin KRAENZLE, Gundelfingen (DE)

(73) Assignee: Roehm GmbH, Sontheim/Brenz (DE)

(21) Appl. No.: 19/224,184

(22) Filed: May 30, 2025

Related U.S. Application Data
(63) Continuation of application No. PCT/EP2023/081885, filed on Nov. 15, 2023.

(30) Foreign Application Priority Data
Nov. 30, 2022 (DE) 10 2022 131 722.6

(51) Int. Cl. B23B 31/10

(52) U.S. Cl. CPC B23B 31/102

(57) ABSTRACT

A chuck jaw having a sensor jaw body and a sensor. A first supporting face and a second supporting face for a chuck insert are formed on the sensor jaw body, which supporting faces are not oriented parallel to each other and are connected via a notch. The sensor is provided in duplicate as strain gauges which are arranged laterally on the sensor jaw body. A chuck insert and a chuck are also provided.

This nonprovisional application is a continuation of International Application No. PCT/EP2023/081885, which was filed on Nov. 15, 2023, which claims priority to German Patent Application No. 10 2022 131 722.6, which was filed in Germany on Nov. 30, 2022, and which are both herein incorporated by reference.

### BACKGROUND OF THE INVENTION

### Field of the Invention

The invention relates to a chuck jaw comprising a sensor jaw body and a sensor, wherein a first supporting face and a second supporting face for a chuck insert are formed on the sensor jaw body, which supporting faces are not oriented parallel to each other and are connected via a notch. The sensor is provided in duplicate as strain gauges which are arranged laterally on the sensor jaw body. The invention further relates to a chuck insert and a chuck.

### Description of the Background Art

The clamping force of a chuck device such as a chuck is subject to various disturbance variables during operation, namely in particular centrifugal forces, friction, or wear. Therefore, despite the known actuation force, the clamping force acting on the tool or workpiece to be clamped is never exactly known, which is disadvantageous with regard to the operation of the chuck device, since insufficient clamping force can cause the clamped object to be flung away. In this case, the cutting force acts perpendicular to the chuck plane via a corresponding lever arm in the form of a high torque/tilting moment and levers the component out of the chuck device. Furthermore, machining accuracy can suffer, as too high a clamping force can lead to deformation.

It is known from DE 10 2019 109 856 A1, which is incorporated by reference, to arrange a sensor for detecting the clamping force on a bending beam on a chuck jaw, wherein holders for an electronic housing and an energy storage unit are formed in the jaw body and further energy and data cables must be inserted in the chuck jaw to connect the components, so that a high level of effort is required for the production of the complexly shaped chuck jaws and their assembly.

In the conventional art, for a set of chuck jaws formed from a plurality of chuck jaws, it is common to use identical chuck jaws that do not differ in terms of their geometry and mass distribution in order to ensure a symmetrical structure of the chuck with matching clamping properties of the chuck jaws and high balancing quality of the chuck device. In chuck jaws suitable for clamping force measurement, this entails a great deal of effort and correspondingly high costs.

### SUMMARY OF THE INVENTION

It is therefore an object of the invention to enable improved monitoring of the clamping forces and cutting forces by providing a suitable chuck jaw, a suitable chuck insert and an improved chuck.

This object is achieved by a chuck jaw in which the sensor is provided in duplicate as strain gauges which are arranged laterally on the sensor jaw body, by a chuck insert, and by a chuck.

The chuck jaw according to the invention is characterized in that the two laterally placed strain gauges measure not only the radially acting clamping force but also a shear force, which acts on the chuck jaw in particular via the cutting force exerted by the cutting tool. The evaluation of the radial force and the shear force enables a more precise description and evaluation of the clamping situation, wherein in particular the previously described tilting moment as a result of the cutting force and the distance to the clamping plane can be measured by the two strain gauges arranged on both sides of the chuck jaw.

It is also provided that the second supporting face is oriented perpendicular to the first supporting face and that the strain gauges are arranged at a distance from the first supporting face and the second supporting face on the side of the notch facing away from them. The choice of where the strain gauges are located has a major influence on the robustness of the measurement result against external influences such as the variable chuck diameter or the difference between internal and external clamping. The location of the strain gauges must therefore be optimized.

The width of the sensor jaw body and the thickness of the structure of the sensor jaw body supporting the second supporting face are chosen in such a way that the maximum possible clamping force can be resisted without a plastic deformation of the structure and/or with an elongation of the structure corresponding to the measuring range of the strain gauges, in order to improve the reproducibility of the measurement results and to provide a stable environment for the strain gauges via the structure.

The strain gauges can be arranged in an area of the structure in which the elongation occurring in the upper area, assigned to the free end, and the compression occurring in the lower region merge into each other, i.e., there is an arrangement along the neutral fiber of the tensile stress and the compressive stress.

The strain gauges can be oriented at an angle to the first supporting face and the second supporting face, as this allows for an adaptation to the direction of the forces acting in the structure, and in particular the strain gauges are oriented relative to the first supporting face and the second supporting face in such a way that the force vectors lying in the plane of the strain gauges perpendicular to the main axes of the strain gauges have the same length.

In addition to the arrangement on the neutral fiber and the determination of the orientation, the position on the neutral fiber is also a free parameter, which is determined by the condition that the strain gauges are placed in an area of equal elongation, which can be determined by the isolines in the area of the notch.

This arrangement of the strain gauges promotes the robustness of the measurement result with regard to each individual parameter and especially in their interaction and, in particular, also creates independence from the clamping height, i.e., the placement of the workpiece in the axial direction, which can be specified by the distance of the workpiece from the first supporting face. Even if the workpiece is not placed directly on the first supporting face, a meaningful measurement result can still be achieved.

The arrangement of the strain gauges on the side of the chuck jaw can be used regardless of the specific design of the chuck jaw and thus also for a chuck jaw in which the sensor jaw body has at least one step with a step head that forms the structure supporting the second supporting face.

It is advantageous if the strain gauges form an angle between 20° and 55°, preferably between 30° and 40° and further preferably of 38° with the first supporting face as this orientation fulfils the aforementioned condition.

The chuck jaw can also be designed as a chuck jaw for face plates, wherein the step head has another second supporting face on the side opposite of the second supporting face with the associated notch and first supporting face. In this case, the arrangement of the strain gauges is chosen such that the longitudinal axis of the strain gauges is at the level of the notch, parallel to the first supporting face.

Provided also is a chuck jaw in which the sensor jaw body can be designed for through-hole clamping, in which the entire clamping surface comes into full contact with a workpiece to be clamped, wherein the strain gauges are oriented with their longitudinal axis parallel to the second supporting face. In this example, due to the material situation, it is not possible to position the strain gauges in the area of the notch in the area of the neutral fiber, so that the displacement takes place in the direction of the free end of the structure, where the aforementioned orientation is then advantageous.

It is also possible that the sensor jaw body can be formed by a base jaw and a top jaw, and that the first supporting face, the second supporting face and the strain gauges are assigned to the top jaw. With this example, a variety of different designs can be used, wherein the base jaw in particular can be optimized with regard to the clamping task.

Peripheral components can be included in the sensor jaw body in at least one holder, wherein the peripheral components may include, for example, an electrical storage unit and/or memory, or other components known to one skilled in the art for recording the data of the strain gauges and/or a processor for processing the data of the strain gauges and/or a transmitter for transmitting the data of the strain gauges. The transmitter for transmitting the data include at least one antenna, but it can happen that the radiation is shaded too much, so that it is advantageous if opposite the antenna, which is preferably located on the mainboard, a second antenna is arranged. The signal strength of the respective antenna at the receiver can be used to decide which antenna is activated, wherein this decision can also be made using an algorithm with no user intervention. The peripheral components may also include cables for transmitting power and/or data that are accommodated in channels of the sensor jaw body. Preferably, the design of the sensor-integrated chuck jaw is made in such a way that a first receptacle for an electronic housing is provided in the sensor jaw body, each of which is connected via a through-hole to the sensor arranged in a pocket, i.e., the strain gauge. A second holder for an energy storage unit is provided in the sensor jaw body, which is connected to the sensor via the through-hole. The chuck jaw is thus designed as a self-sufficient unit that can also be completely replaced in a simple manner. It should be noted that the electronic housing also accommodates the corresponding components for recording the clamping force and retransmission, namely in particular a carrier board with a microprocessor, connections for supplying and evaluating the sensors formed as strain gauges and additional sensors, for example, for measuring the speed and/or temperature. Furthermore, evaluation and/or transmission electronics can be assigned to the housing in order to make the data recorded by the sensors available wirelessly to the machine control of a machine tool as raw data or processed accordingly. The energy supply for this is provided by the energy storage system, which is usually a rechargeable battery, i.e., an accumulator.

Accurate measurement of the clamping force is already possible with this type of sensor-integrated chuck jaw, so that sensorless chuck jaws can also be used in a jaw set for the chuck, whose vertical range of manufacture can be drastically reduced, so that the time and costs required for this sensorless chuck jaw are also reduced. For redundancy reasons, a chuck jaw set can contain more than one sensor-integrated chuck jaw, and more than one sensorless chuck jaw can also be used as a complementary quantity to the sensor-integrated chuck jaws. Due to its design and construction, the sensorless chuck jaw exhibits a deformation behavior that is almost identical to the sensor-integrated chuck jaw, or ideally identical, while retaining the outer contour.

It is possible to form the sensorless chuck jaw solidly in the required shape for particularly simple production. However, it is particularly preferable if the sensorless chuck jaw has at least one balancing mount for holding a balancing mass, wherein the position and size of the balancing mount and the assigned balancing mass are selected to achieve the desired mechanical properties. The arrangement of the balancing mount and the introduction of the balancing mass thus ensures that the deformation behavior is the same as the sensor-integrated chuck jaw and that the required balancing quality is achieved even at high speeds. Finite element simulations can be used to examine, check, and verify the desired properties for different jaw positions in a chuck, in the internal and external clamping of workpieces and when using different jaw stages. Improved variability with more degrees of freedom for achieving the desired goal is given if several of the balancing mounts are formed in the jaw body. Again, in terms of simplicity of production and sensitivity in tuning, it is preferable if the balancing mount is designed as a threaded hole, and if a set of threaded pins with different mass and/or lengths is provided for the threaded hole. From the set of threaded pins, one threaded pin can therefore be selected with which the desired goal is achieved, wherein more than one threaded pin can also be screwed into a threaded hole if necessary. It should also be noted that the properties in terms of mass and distribution can be influenced by the fact that the threaded pins are screwed into the threaded hole to different lengths. Increased variability also results if several of the balancing mounts emanate from one side of the jaw body from its surface, and if balancing mounts emanate from several sides of the jaw body.

The possible applications and the duration of use of the chuck jaws according to the invention can be extended if chuck inserts can be attached to the chuck jaws. According to an example of the invention, a chuck insert is formed with a base body, on which a chuck surface intended for attachment to a workpiece is formed, and, on the side opposite of the chuck surface, a contact surface intended for the application of a force into a chuck jaw, wherein a first structure for translational position securing and a second structure for rotational position securing is assigned to the base body. This design takes into account that in addition to the clamping force, the shear force can and should also be measured, which means that a good and reproducible determination of the position of the chuck insert on the chuck jaw is desired, which, as a wearing part, must be changed repeatedly during the service life of the chuck jaw.

The first structure can be formed by a through-hole opening to accommodate a screw, preferably a socket head screw. In this way, the chuck insert can be attached to the chuck jaw with a short set-up time. It is also preferable if the second structure is formed as a torque support assigned to the contact surface that enables a positive fit. It is possible that the second structure is formed by a pin protruding from the contact surface or a pin holder formed in the contact surface. The pin can be placed at a distance from the through-hole opening.

The second structure may have two receiving tabs protruding from the edge of the contact surface, with the receiving tabs projecting beyond the base body on one side.

The chuck jaw can have a complementary design for interaction with the first structure, i.e., in particular a thread holder, and the second structure, i.e., in particular a pin holder or a pin.

The design of the clamping surface can be selected from a group that includes a hard stepped top jaws, claws, and ribbing.

The advantages and effects mentioned above also apply mutatis mutandis to a chuck comprising at least one sensor-integrated chuck jaw.

Further scope of applicability of the present invention will become apparent from the detailed description given hereinafter. However, it should be understood that the detailed description and specific examples, while indicating preferred embodiments of the invention, are given by way of illustration only, since various changes, combinations and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective representation of a chuck with three chuck jaws,

FIG. 2 shows a perspective representation of a sensor-integrated chuck jaw in the example as a 1-stage chuck jaw,

FIG. 3 shows a side view of the sensor-integrated chuck jaw from FIG. 2, with a representation of the position of the neutral fiber with regard to compressive stress and tensile stress,

FIG. 4 shows a side view of the sensor-integrated chuck jaw from FIG. 2, with a vector representation of the main axis system in the direction of the 1st main stress for determining the orientation of the strain gauge,

FIG. 5 shows a side view of the sensor-integrated chuck jaw from FIG. 2, with a representation of the isolines of the elongation around the notch,

FIG. 6 shows a superimposition of the representations from FIGS. 3 to 5 to illustrate the determination of the position and orientation of the strain gauge,

FIG. 7 shows a side view of the sensor-integrated chuck jaw from FIG. 2, inserted into a guide holder of a chuck that is only partially shown, with an example regarding the chuck height of the workpiece,

FIG. 8 shows a representation of a sensor-integrated chuck jaw corresponding to FIG. 2 in the example as a through-hole chuck jaw,

FIG. 9 shows a side view with a transparent representation of the chuck jaw from FIG. 8,

FIG. 10 shows a perspective, transparent representation of the chuck jaw from FIG. 9,

FIG. 11 shows a representation of a sensor-integrated chuck jaw corresponding to FIG. 2 in the example as a chuck jaw for face plates, and

FIG. 12 shows a perspective, transparent representation of the chuck jaw from FIG. 11.

### DETAILED DESCRIPTION

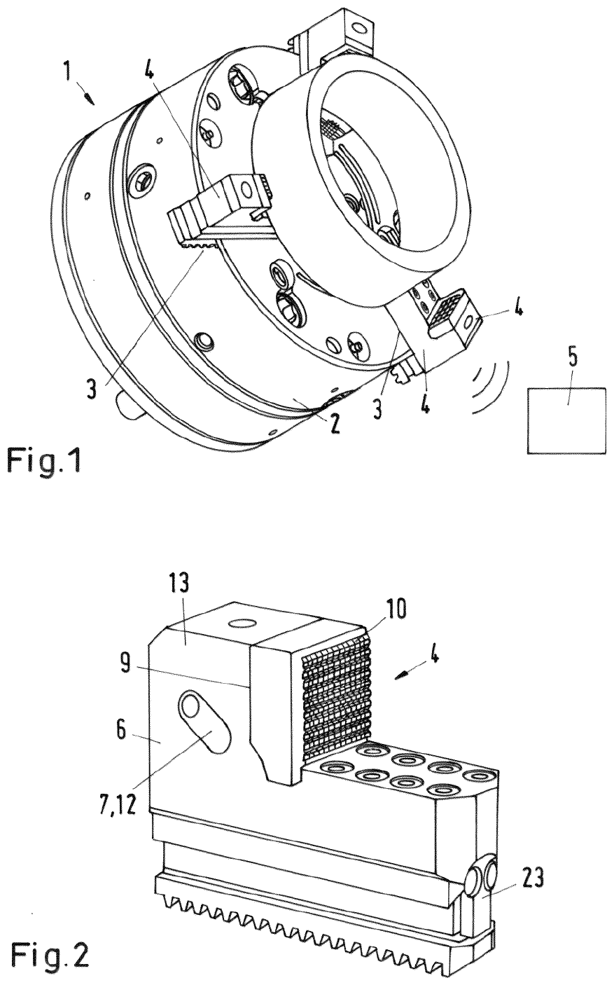

FIG. 1 shows a chuck 1 which has a chuck body 2 in which chuck jaws 4 are arranged in radial jaw guides 3, evenly distributed over the circumference in the example shown. In the example shown, three radial jaw guides 3 are shown, but a different number of radial jaw guides 3 with assigned chuck jaws 4 is also possible, in particular also a chuck 1 with two chuck jaws 4 or more than three chuck jaws 4, namely four, five, six, seven or more than seven chuck jaws 4. In normal use, the chuck 1 is assigned to the working spindle of a machine tool in the usual manner, wherein the rotating drive of the chuck 1 is carried out by the machine tool and the actuation force is provided to generate the desired clamping force.

Of the three jaws 4 shown, at least one is formed as a chuck jaw 4 comprising a sensor jaw body 6 and a sensor 7, wherein a first supporting face 8 and a second supporting face 9 for a chuck insert 10 are formed on the sensor jaw body 6, which supporting faces are not oriented parallel to each other and are connected via a notch 11 (FIGS. 2 and 4); thus there is a sensor-integrated chuck jaw 4. The sensor 7 is provided in duplicate as strain gauges 12 which are arranged laterally on the sensor jaw body 6. The receiving unit 5 shown in FIG. 1 is usually part of the machine tool for receiving data to be transmitted wirelessly from at least one of the sensor-integrated chuck jaws 4 inserted in the chuck 1.

FIGS. 2 to 11 show that the second supporting face 9 is oriented perpendicular to the first supporting face 8, wherein the strain gauges are arranged at a distance from the first supporting face 8 and the second supporting face 9 on the side of the notch 11 facing away from them. The width of the sensor jaw body 6 and the thickness of the structure 13 of the sensor jaw body 6 supporting the second supporting face 9 is chosen in such a way that the maximum possible clamping force can be resisted without a plastic deformation of the structure 13 and/or with an elongation of the structure 13 corresponding to the measuring range of the strain gauges.

The example of a sensor-integrated chuck jaw 4 shown in FIG. 2 comprises a sensor jaw body 6 with a jaw step 14, which forms the structure 13 for the first supporting face 8 and the second supporting face 9. On this structure 13, a chuck insert 10 is arranged. In the example shown, a jaw step 14 is shown, but it is true that a different number is possible, i.e., a chuck jaw 4 can also be realized with more than one jaw step 14, depending on the requirements of the required chuck ratios.

It should be noted that the sensor jaw body 6 of the chuck jaw 4 is designed as a reversable step jaw, i.e., it is possible to easily change between an external clamping shown in FIG. 1 and an internal clamping by simply turning the chuck jaws 4 in the jaw guides 3 of the chuck 1.

The sensor point for the two laterally arranged strain gauges 12 is each formed from a pocket 15 in which the strain gauge 12 is arranged, which is formed in particular as a metal strain gauge and welded on in the pocket 15, wherein the contact surfaces are arranged via a through-hole 16, which is provided for the passage of a data line and/or an energy supply line. It should also be noted that in order to protect the sensor 7, the pocket 15 holding the sensor 7 is closed by a cover, which can preferably only be removed destructively.

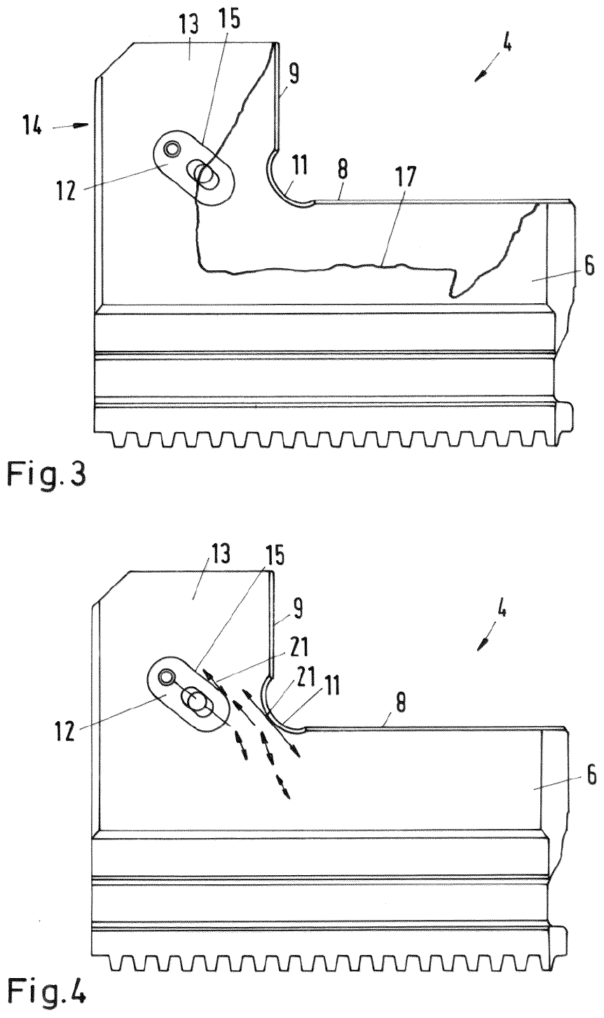

FIGS. 3 to 6 indicate that the strain gauges 12 are arranged in a region of the structure 13 in which the elongation occurring in the upper region assigned to the free end and the compression occurring in the lower region merge into each other, thus defining a neutral fiber 17 in terms of compressive stress and tensile stress.

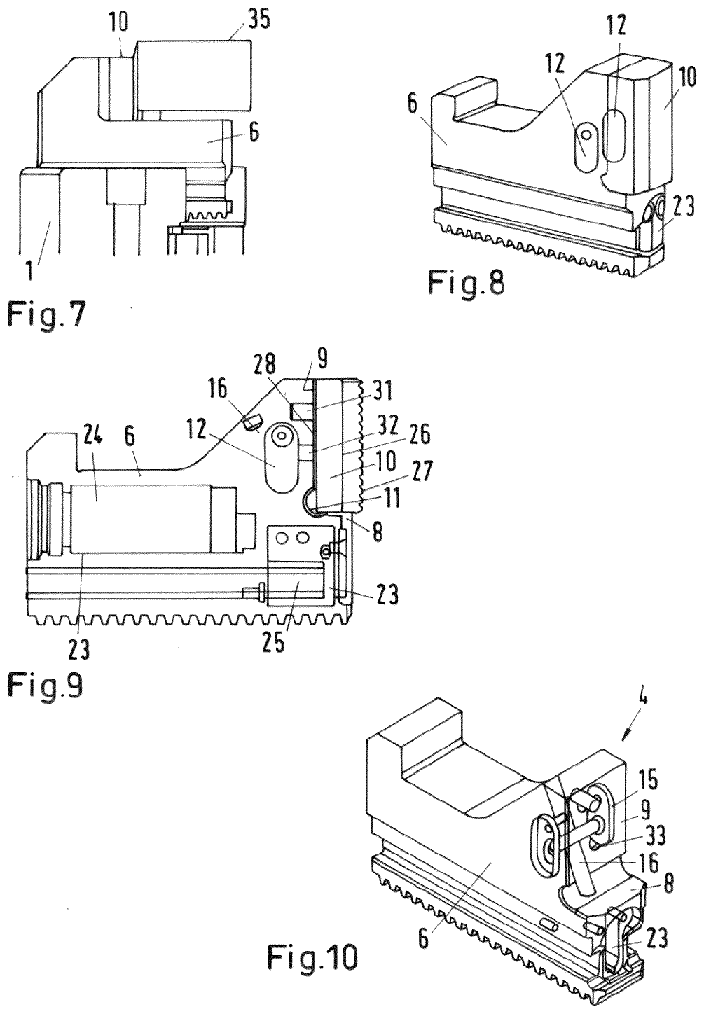

It should be noted that in the example shown in FIG. 2, the sensor jaw body 6 has at least the jaw step 14 with a step head that forms the structure 13 supporting the second supporting face 9. The strain gauges 12 are oriented at an angle to the first supporting face 8 and the second supporting face 9, in such a way that the strain gauges 12 are oriented relative to the first supporting face 8 and the second supporting face 9, in such a way that the force vectors 21 lying in the plane of the strain gauges 12 perpendicular to the main axes of the strain gauges 12 have the same length, that is, according to FIG. 7, the longitudinal axis of the strain gauges 12 forms an angle between 20° and 55°, preferably between 30° and 40° and further preferably of 38° with the first supporting face 8.

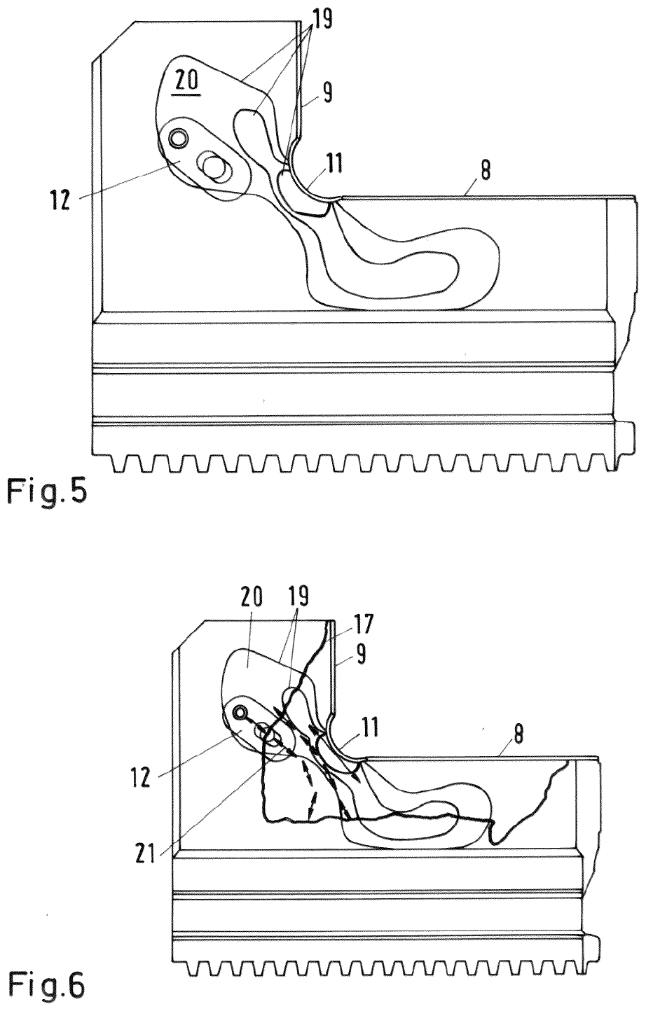

On the basis of the isolines 19 with regard to the elongation shown in FIG. 5, the position of a region of equal elongation 20 can be seen.

FIG. 6 illustrates how the position of the strain gauge 12 and its orientation in individual process steps, in particular mathematically, are determined on the basis of the parameters explained above, in order to achieve a high degree of robustness of the measurement results with regard to the influences of the clamping situation, i.e., to reduce the influence of internal stress and external tension, the clamping height or the clamping diameter in order to determine both the clamping force and the shear force.

A further alternative design of the chuck jaw 4 for the application in the case of through-hole clamping, in which the entire clamping surface 27 comes into full contact with the workpiece 35 to be clamped, is shown in FIGS. 8 to 10, wherein the design is such that the strain gauges 12 are oriented parallel with their longitudinal axis to the second supporting face 9.

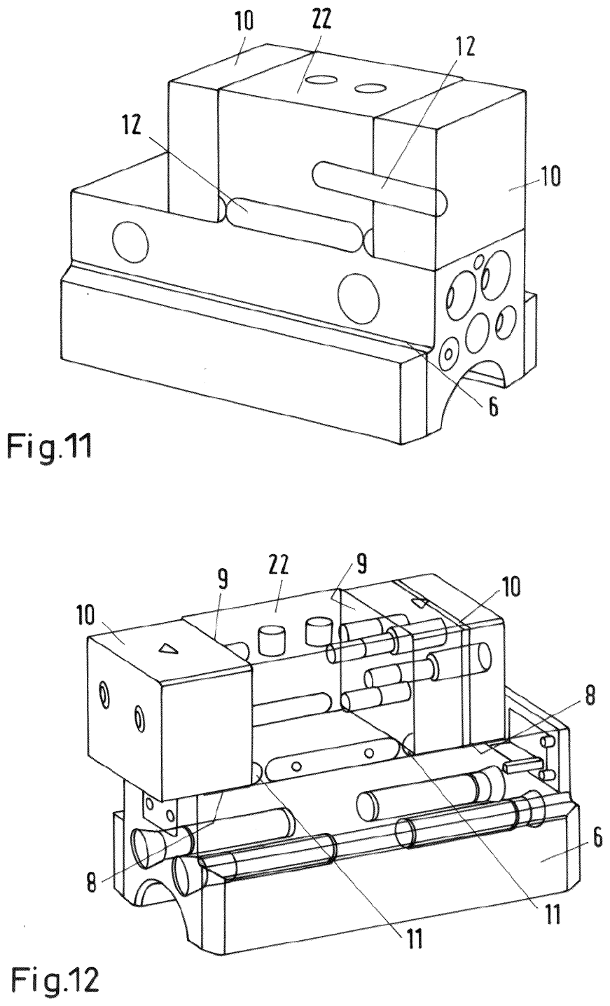

FIGS. 11 and 12 show an example of the chuck jaw 4 for clamping face plates, wherein a step head 22 has a further second supporting face 9 on the side opposite of the second supporting face 9 with the associated notch 11 and first supporting face 8. The longitudinal axis of the strain gauges 12 is at the level of the notch 11, oriented parallel to the first supporting face 8.

FIG. 9 shows that in at least one holder 23, peripheral components are included in the sensor jaw body 6, wherein the peripheral components may include an electrical storage unit 24 and/or storage 25 for recording the data of the strain gauges 12 and/or a processor for processing the data of the strain gauges and/or a transmitter for transmitting the data of the strain gauges. The peripheral components also include cables for the transmission of energy and/or data, which are accommodated in channels/through-holes 16 of the sensor jaw body 6. This design is shown as an example for a feed-through jaw but can also be used for the examples of chuck jaws 4.

The sensor jaw body 6 may be formed by a base jaw and a top jaw, wherein the first supporting face 8, the second supporting face 9 and the strain gauges 12 are assigned to the top jaw, and the base jaw preferably has the holders 23 for the peripheral components.

FIG. 9 shows in particular a chuck insert 10 attached to the chuck jaw 4 with a base body 26, on which a clamping surface 27 intended for attachment to a workpiece and, on the side opposite of the chuck surface 27, a contact surface 28 intended for applying a force to the chuck jaw 4 are formed, wherein a first structure 29 for translational position protection and a second structure 30 for rotational position protection is assigned to the base body 26 to which complementary structures are provided at the chuck jaw 4.

The first structure 29 is formed by a through-hole opening for the reception of a screw 31, preferably a socket head screw, whereas in the example shown the second structure 30 is formed as a torque support, which enables a positive fit and is assigned to the contact surface, namely by a pin 32 protruding from the contact surface 28 which protrudes into a pin holder 33 of the chuck jaw 4. The pin 32 is spaced at a distance from the through-hole opening.

FIG. 2 shows an example with regard to the second structure 30, which has two receiving tabs 34 protruding from the edge of the contact surface 28, which project beyond the base body 26 on one side.

The design of the clamping surface 27 on the chuck inserts 10 is selected from a group that includes a hard stepped top jaws, claws, a ribbing.

It is possible that in the chuck 1 shown in FIG. 1, all chuck jaws 4 used are designed as sensor-integrated chuck jaws, since greater accuracy can be achieved by averaging and it can also be checked whether a sensor-integrated chuck jaw 4 shows deviating measured values that indicate a defect compared to the others, i.e., the functionality of the sensor-integrated chuck jaws 4 can be evaluated in real time. However, such sensor-integrated jaws 4 are relatively expensive, so that a chuck jaw set with at least one sensor-integrated chuck jaw 4 can also be used, which comprises at least one sensorless chuck jaw 4, which has a jaw body whose stiffness, mass and center of gravity corresponds to the sensor jaw body 6, wherein the sensorless chuck jaw 4 then has at least one balancing mount to hold a balancing mass. The balancing mount is preferably designed as a threaded hole arranged in the jaw body, wherein a set of threaded pins with different mass and/or lengths is provided for the threaded hole, so that the chuck jaws 4 show identical deformation behavior and the stiffness, mass and center of gravity are almost identical and the required balancing quality and transmission of the clamping force is given even at high speeds.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A chuck jaw comprising:
a sensor jaw body;
a sensor; and
a first supporting face and a second supporting face for a chuck insert are formed on the sensor jaw body, the first and second supporting faces are not oriented parallel to each other and are connected via a notch,
wherein the sensor is provided in duplicate as strain gauges that are arranged laterally on the sensor jaw body.

2. The chuck jaw according to claim 1, wherein the second supporting face is oriented perpendicular to the first supporting face, and that the strain gauges are arranged at a distance from the first supporting face and the second supporting face on a side of the notch facing away from them.

3. The chuck jaw according to claim 1, wherein the width of the sensor jaw body and the thickness of the structure of the sensor jaw body supporting the second supporting face is chosen such that a maximum possible clamping force is adapted to be resisted without a plastic deformation of the structure and/or with an elongation of the structure corresponding to the measuring range of the strain gauges.

4. The chuck jaw according to claim 3, wherein the strain gauges are arranged in a region of the structure in which the elongation occurring in the upper region assigned to the free end and the compression occurring in the lower region merge into each other.

5. The chuck jaw according to claim 3, wherein the strain gauges are oriented at an angle to the first supporting face and the second supporting face.

6. The chuck jaw according to claim 5, wherein the strain gauges are oriented relative to the first supporting face and the second supporting face such that the force vectors lying in the plane of the strain gauges perpendicular to the main axes of the strain gauges have the same length.

7. The chuck jaw according to claim 1, wherein the sensor jaw body has at least one jaw step with a step head that forms the structure supporting the second supporting face.

8. The chuck jaw according to claim 7, wherein the step head has a further second supporting face on the side opposite of the second supporting face with the associated notch and first supporting face.

9. The chuck jaw according to claim 8, wherein the longitudinal axis of the strain gauges lies at the level of the notch, oriented parallel to the first supporting face.

10. The chuck jaw according to claim 1, wherein the sensor jaw body is designed for through-hole clamping in which the entire clamping surface comes into full contact with a workpiece to be clamped, and that the strain gauges (are oriented with their longitudinal axis parallel to the second supporting face.

11. The chuck jaw according to claim 1, wherein the sensor jaw body is formed by a base jaw and a top jaw, and that the first supporting face, the second supporting face, and the strain gauges are assigned to the top jaw.

12. The chuck jaw according to claim 1, wherein peripheral components are included in the sensor jaw body in at least one holder, wherein the peripheral components include an electrical storage unit and/or a recorder for recording the data of the strain gauges and/or a processor for processing the data of the strain gauges and/or a transmitter for transmitting the data of the strain gauges, which include at least one first antenna and a second antenna for avoiding shadowing effects of the first antenna, and/or wherein the peripheral components include cables for the transmission of energy and/or data received in through-holes of the sensor jaw body.

13. A chuck insert comprising:
a base body on which a clamping surface intended for attachment to a workpiece to be clamped and, on a side opposite of the clamping surface, a contact surface intended for applying a force to a chuck jaw is formed; and
a first structure for translational position securing and a second structure for rotational position securing are assigned to the base body.

14. The chuck insert according to claim 13, wherein the first structure is formed by a through-hole opening for holding a screw.

15. The chuck insert according to claim 13, wherein the second structure is formed as a torque support enabling a positive fit and assigned to the contact surface.

16. The chuck insert according to claim 15, wherein the second structure is formed by a pin protruding from the contact surface or a pin holder formed in the contact surface.

17. The chuck insert according to claim 13, wherein the second structure has two receiving tabs protruding from the edge side of the contact surface.

18. A chuck comprising at least one chuck jaw according to claim 13.
